(19) United States
(12) Patent Application Publication
(10) Pub. No.: US 2022/0328016 A1
(43) Pub. Date: Oct. 13, 2022

(54) Data Driver, Control Method thereof, and Display Device

(71) Applicants: Hefei BOE Display Technology Co., Ltd., Hefei, Anhui (CN); BOE Technology Group Co., Ltd., Beijing (CN)

(72) Inventors: Huiming WANG, Beijing (CN); Min WANG, Beijing (CN); Rongcheng LIU, Beijing (CN); Xiuqin YANG, Beijing (CN); Jing MA, Beijing (CN); Peng ZHAO, Beijing (CN)

(21) Appl. No.: 17/417,389

(22) PCT Filed: Dec. 29, 2020
(86) PCT No.: PCT/CN2020/140911

§ 371 Date: Jun. 23, 2021

(30) Foreign Application Priority Data
Mar. 19, 2020 (CN) 202010206097.7

(51) Int. Cl. G09G 3/36

(52) U.S. Cl. CPC G09G 3/3688; G09G 2310/08; G09G 2330/025; G09G 2330/026; G09G 2320/0257; G09G 2310/0291

(57) ABSTRACT

A data driver is provided, which includes a control unit, a data distribution unit, a first driving unit and a second driving unit. The data distribution unit is respectively coupled with the input terminal of the first driving unit and the input terminal of the second driving unit, and is configured to provide a first data distribution signal to the input terminal of the first driving unit and a second data distribution signal to the input terminal of the second driving unit; The first driving unit is configured to generate a first data signal according to a first data distribution signal, and the second driving unit is configured to generate a second data signal according to a second data distribution signal, and voltage polarities of the first data signal and the second data signal are different.

The present application claims the priority of Chinese patent application No. 202010206097.7, filed to the CNIPA on Mar. 19, 2020 and entitled “Data Driver and Control Method thereof, Display Device”, the content of which should be regarded as being incorporated to the present application herein by reference.

### TECHNICAL FIELD

The present disclosure relates to, but is not limited to, the field of display technology, and in particular, to a data driver, a control method thereof and a display device.

### BACKGROUND

With the continuous development of liquid crystal display technology, large-size and high-resolution liquid crystal display devices have attracted wide attention. However, due to the large panel size and high resolution of the liquid crystal display device, the charging time of a single pixel is short, which will lead to insufficient charging rate, resulting in short-term line afterimage, and there is also the problem of large current Inrush.

### SUMMARY

The following is a summary of subject matter described in detail herein. This summary is not intended to limit the protection scope of the claims.

The present disclosure provides a data driver, a control method thereof, and a display device.

In one aspect, the present disclosure provides a data driver including a control unit, a data distribution unit, a first driving unit and a second driving unit. The data distribution unit is coupled with an input terminal of the first driving unit and an input terminal of the second driving unit respectively and is configured to provide a first data distribution signal to the input terminal of the first driving unit and a second data distribution signal to the input terminal of the second driving unit. The first driving unit is configured to generate a first data signal according to the first data distribution signal, and the second driving unit is configured to generate a second data signal according to the second data distribution signal, voltage polarities of the first data signal and the second data signal being different. The control unit is coupled with the input terminal of the first driving unit and the input terminal of the second driving unit respectively, and is configured to control the input terminal of the first driving unit and the input terminal of the second driving unit to be in short circuit or disconnected according to a power-on reset signal.

In another aspect, the present disclosure provides a display device including the data driver as described above.

In another aspect, the present disclosure provides a control method to be applied to the data driver described above. The control method includes that the control unit controls the input terminal of the first driving unit and the input terminal of the second driving unit to be in short circuit or disconnected according to the power-on reset signal.

Other aspects will become apparent upon after the drawings and the detailed description are read and understood.

### BRIEF DESCRIPTION OF DRAWINGS

Accompanying drawings are used to provide an understanding of technical solutions of the present disclosure and form a part of the specification. Together with embodiments of the present disclosure, they are used to explain technical solutions of the present disclosure but do not constitute a limitation on the technical solutions of the present disclosure.

FIG. 1 is a diagram showing a relationship between gate-source voltage (Vgs) and charging current (Ids) of a thin film transistor in a liquid crystal display device.

FIG. 2 is a schematic diagram showing the asymmetry of the actual pixel charging voltages of data signals with different voltage polarities relative to the common voltage.

FIG. 3 is a schematic diagram of separate control for a first data signal and a second data signal with different voltage polarities in an embodiment of the present disclosure;

FIG. 4 is a schematic diagram of power supply for a data driver according to an embodiment of the present disclosure.

FIG. 5 is a schematic diagram of large current Inrush.

FIG. 6 is a schematic diagram of the structure of a data driver according to an embodiment of the present disclosure.

FIG. 7 is a schematic diagram of a first data distribution signal and a second data distribution signal in an embodiment of the present disclosure.

FIG. 8 is a schematic diagram of the structure of a data driver according to another embodiment of the present disclosure.

FIG. 9 is a schematic diagram of the effect of a data driver in an embodiment of the present disclosure.

FIG. 10 is a flowchart of the operation of a data driver in an embodiment of the present disclosure.

### DETAILED DESCRIPTION

A plurality of embodiments are described in the present disclosure, but the description is exemplary rather than restrictive, and it is apparent to those of ordinary skills in the art that there may be more embodiments and implementation solutions within the scope of the embodiments described in the present disclosure. Although many possible combinations of features are shown in the drawings and discussed in the embodiments, many other combinations of the disclosed features are also possible. Unless specifically limited, any feature or element of any embodiment may be used in combination with or in place of any other feature or element of any other embodiment.

The present disclosure includes and contemplates combinations of features and elements known to those of ordinary skilled in the art. The disclosed embodiments, features and elements of the present disclosure may be combined with any conventional features or elements to form a unique scheme defined by the claims. Any feature or element of any embodiment may alternatively be combined with features or elements from other schemes to form another unique scheme defined by the claims. Therefore, it should be understood that any of the features shown and discussed in the present disclosure may be implemented individually or in any suitable combination. Therefore, the embodiments are not otherwise limited except in accordance with the appended claims and equivalents thereof. In addition, one or more modifications and alterations may be made within the protection scope of the appended claims.

Furthermore, when describing representative embodiments, the specification may have presented a method or process as a specific order of acts. However, to the extent that the method or process does not depend on the specific order of steps described herein, the method or process should not be limited to the specific order of steps described. As those of ordinary skills in the art will understand, other orders of steps are also possible. Therefore, the specific order of steps set forth in the specification should not be interpreted as limiting the claims. Furthermore, the claims for the method or process should not be limited to performing the acts in the order of the acts defined in the claims, and those skilled in the art can easily understand that these orders may be varied but still remain within the essence and scope of the embodiments of the present disclosure.

In the drawings, a size of a constituent element, or a thickness of a layer or an area, is sometimes exaggerated for clarity. Therefore, an implementation of the present disclosure is not necessarily limited to the size shown, and a shape and size of each component in the drawings do not reflect true proportions. In addition, the drawings schematically show ideal examples, and an implementation of the present disclosure is not limited to the shapes or values shown in the drawings.

Unless otherwise defined, technical terms or scientific terms used in the present disclosure shall have ordinary meanings understood by those of ordinary skills in the art to which the present disclosure belongs. The words “first”, “second” and the like used in the present disclosure do not indicate any order, quantity or importance, but are only used to distinguish different components. In the present disclosure, “multiple” may mean two or more than two. Similar words such as “including” or “containing” mean that elements or articles appearing before the word cover elements or articles listed after the word and their equivalents, without excluding other elements or articles. Similar terms such as “couple”, “connect” or “link” are not limited to physical or mechanical connections, but may include electrical connections, whether direct or indirect. “Electrical connection” includes a case where constituent elements are connected together through an element with certain electrical effects. The “element with a certain electric action” is not particularly limited as long as it can transmit and receive electrical signals between the connected constituent elements. Examples of “the element with the certain electrical effect” not only include an electrode and wiring, but also a switching element such as a transistor, a resistor, an inductors, a capacitor, and another element with one or more functions.

In order to make the following description of the embodiments of the present disclosure clear and concise, detailed description of some of known functions and known components are omitted in the present disclosure. The drawings of the embodiments of the present disclosure only relate to structures involved in the embodiments of the present disclosure, and for other structures, general designs may be referred to.

The liquid crystal display device comprises a gate driving circuit, a source driving circuit, a plurality of scanning lines, a plurality of data lines and a plurality of sub-pixel areas formed by the interweaved scanning lines and the data lines. The plurality of scanning lines are connected to the gate driving circuit which provides gate driving signals to the plurality of sub-pixels via the plurality of scanning lines. The plurality of data lines are connected to the source driving circuit which provides display signals to the plurality of sub-pixels via the plurality of data lines. A Thin Film Transistor (TFT) is provided in each sub-pixel area, the gate of the TFT being coupled with the scanning line, the source of the TFT being connected with the data line, and the drain of the TFT being coupled with the pixel electrode. The on and off of the thin film transistor can be controlled by the signal of the scanning line, and whether the signal from the data line (i.e., the data signal) is written into the pixel electrode is thereby controlled. The luminous intensity of each sub-pixel of the liquid crystal display device is determined by the voltage difference applied between a pixel electrode of the sub-pixel and a common electrode.

In order to prevent the polarization of liquid crystal, liquid crystal display devices often adopt the driving mode of polarity inversion, which is to switch the positive and negative polarity of the voltage of the data signal input to the a sub-pixel. The driving modes of polarity inversion include frame inversion, row inversion, column inversion and dot inversion. For example, for two adjacent frames, the voltage polarity of the data signals input to the pixel electrodes in one frame is positive (i.e. positive frame driving) while the voltage polarity of the data signals input to the pixel electrodes in the other frame is negative (i.e. negative frame driving). Alternatively, for adjacent two rows of sub-pixels, the voltage polarity of the data signals input to the pixel electrodes of one row of sub-pixels is positive while the voltage polarity of the data signals input to the pixel electrodes of the other row of sub-pixels is negative.

FIG. 1 is a diagram showing the relationship between gate-source voltage (Vgs) and charging current (Ids) of a TFT in a liquid crystal display device. In FIG. 1, the abscissa is the gate-source voltage of TFT in volts (V); The ordinate is the charging current of TFT in amperes (A). It can be seen from FIG. 1 that when Vgs is greater than −10V, the larger Vgs is, the larger the charging current is and the shorter the time required for fully charging the pixel electrode is (i.e. fast charging), while the smaller Vgs is, the smaller the charging current is and the longer the time required for fully charging the pixel electrode is (i.e. slow charging).

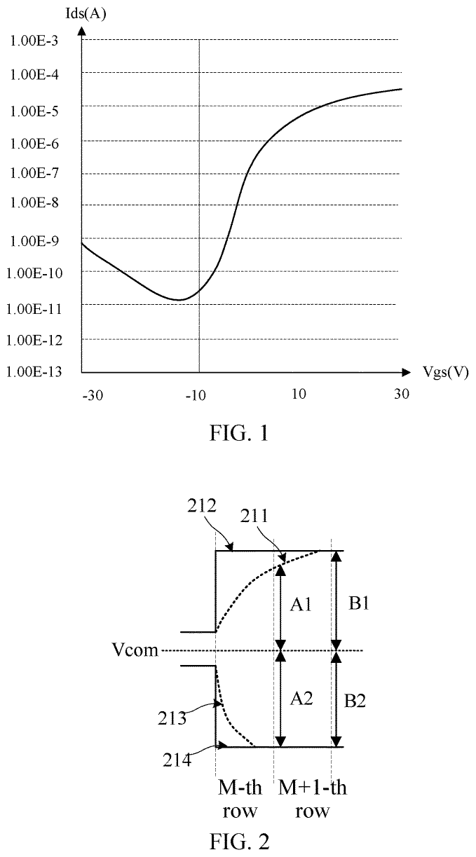

FIG. 2 is a schematic diagram showing the asymmetry of the actual pixel charging voltages of data signals with different voltage polarities relative to the common voltage (Vcom). In FIG. 2, 211 is the pixel voltage actually charged to the pixel electrode of the positive frame sub-pixel during positive frame driving, which can be referred to as positive frame original pixel voltage. 212 is the data voltage input by the data line coupled to the positive frame sub-pixel during positive frame driving, which can be referred to as positive frame original data voltage. 213 is the pixel voltage actually charged to the pixel electrode of the negative frame sub-pixel during negative frame driving, which can be referred to as negative frame original pixel voltage, and 214 is the data voltage input by the data line coupled to the negative frame sub-pixel during negative frame driving, which can be referred to as negative frame original data voltage. It can be seen from FIG. 2 that the time required to charge the pixel voltage of the pixel electrode to the positive frame original data voltage 212 during positive frame driving is longer than the time required to charge the pixel voltage of the pixel electrode to the negative frame original data voltage 214 during negative frame driving.

As shown in FIG. 2, for the sub-pixels in the m-th row, the pixel voltage of the positive frame sub-pixel has not yet reached the positive frame original data voltage 212, while the pixel voltage of the negative frame sub-pixel has reached the negative frame original data voltage 214, which causes the positive frame original pixel voltage 211 on the pixel electrode of the m-th positive frame sub-pixel and the negative frame original pixel voltage 213 on the pixel electrode of the m-th negative frame sub-pixel to be asymmetric relative to the common voltage (Vcom). That is, under positive frame driving and negative frame driving, the absolute value A1 of the voltage difference between the positive frame original pixel voltage 211 of the m-th positive frame sub-pixel and the common voltage and the absolute value A2 of the voltage difference between the negative frame original pixel voltage 213 of the m-th negative frame sub-pixel and the common voltage are not equal. There is a large difference between A1 and A2, and the difference is a direct current component.

As shown in FIG. 2, if the pixel voltage of positive frame sub-pixels in the m+1-th row can reach the positive frame original data voltage, then the positive frame original pixel voltage on the pixel electrodes of positive frame sub-pixels in the m+1-th row and the negative frame original pixel voltage on the pixel electrodes of negative frame sub-pixels in the m+1-th row are symmetrical relative to the common voltage. That is, under positive frame driving and negative frame driving, the absolute value B1 of the voltage difference between the positive frame original pixel voltage of the positive frame sub-pixels in the m+1-th row and the common voltage and the absolute value B2 of the difference between the negative frame original pixel voltage of the negative sub-pixels in the m+1-th row and the common voltage are equal.

In actual charging, when the liquid crystal display device changes from black to white, as Vgs of the driving transistor of the negative frame sub-pixel is about 32V, the charging speed of the negative frame sub-pixel is fast, while as the Vgs of the driving transistor of the positive frame sub-pixel is about 16V, the charging speed of the positive frame sub-pixels is slow. As a result, the actual pixel charging voltages of the positive frame sub-pixels and the negative frame sub-pixels are asymmetric with respect to the common voltage Vcom, which will generate a significant Direct Current (DC) bias in the first black to white line, resulting in short-term DC line afterimages.

Due to the insufficient charging rate of large-size and high-resolution liquid crystal display devices and the influence of Vgs of driving transistors on the charging rate, the charging rates of positive frame sub-pixels and negative frame sub-pixels are obviously different, which will lead to obvious bias on black-and-white boundary of liquid crystal display devices and serious short-term line afterimage.

Embodiments of the present disclosure provide a data driver, a control method thereof, and a display device, which can alleviate short-term line afterimage and inhibit heavy current Inrush and can thereby improve circuit stability and safety.

An embodiment of the present disclosure provides a data driver including a control unit, a data distribution unit, a first driving unit and a second driving unit. The data distribution unit is coupled with an input terminal of the first driving unit and an input terminal of the second driving unit respectively and is configured to provide a first data distribution signal to the input terminal of the first driving unit and a second data distribution signal to the input terminal of the second driving unit. The first driving unit is configured to generate a first data signal according to the first data distribution signal, and the second driving unit is configured to generate a second data signal according to the second data distribution signal, voltage polarities of the first data signal and the second data signal being different. The control unit is coupled with the input terminal of the first driving unit and the input terminal of the second driving unit respectively, and is configured to control the input terminal of the first driving unit and the input terminal of the second driving unit to be in short circuit or disconnected according to a power-on reset signal.

In this embodiment, the quantity of first driving units may be plurality, and the quantity of second driving units may be plurality. The data distribution unit may provide each first driving unit with a first data distribution signal and each second driving unit with a second data distribution signal. The control unit can be coupled with the input terminals of the plurality of first driving units and with the input terminals of the plurality of second driving units respectively and can control the input terminals of the first driving units and the input terminals of the second driving units to be in short circuit or disconnected according to the power-on reset signal. In this embodiment, the first driving unit and the second driving unit may be a positive frame driving unit and a negative frame driving unit respectively. The first data signal provided by the first driving unit and the second data signal provided by the second driving unit can be provided to different data lines to charge pixel electrodes of different sub-pixels.

In this embodiment, the short-term line afterimage can be alleviated by separately controlling the first data signal and the second data signal with different voltage polarities. A situation where voltage polarity of the first data signal is positive and the voltage polarity of the second data signal is negative is taken as an example. FIG. 3 is a schematic diagram of separate control for a first data signal and a second data signal with different voltage polarities. As shown in FIG. 3, 215 is the pixel voltage actually charged to the pixel electrode of the positive frame sub-pixel during positive frame driving, and 216 is the data voltage provided by the first data signal during positive frame driving. 217 is the pixel voltage actually charged to the pixel electrode of the negative frame sub-pixel during negative frame driving, and 218 is the data voltage provided by the second data signal during negative frame driving. The falling edge delay time D of the second data signal is greater than the rising edge delay time Tr of the first data signal (Tr is 0 as shown in FIG. 3). In FIG. 3, the actual charging voltage of positive frame sub-pixels and the actual charging voltage of negative frame sub-pixel are symmetrical relative to the common voltage. In comparison with the case where the positive frame original pixel voltage and the negative frame original pixel voltage are asymmetric with respect to the common voltage as shown in FIG. 2, in this embodiment, by increasing the delay time of the falling edge of the negative frame pixel voltage, the position bias of the first line from black to white can be offset and the line afterimage can be thereby alleviated.

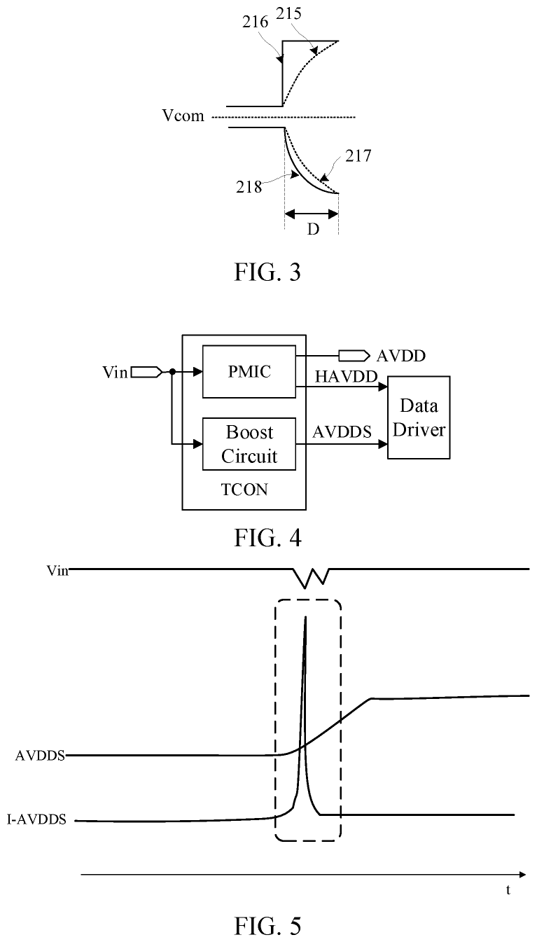

FIG. 4 is a schematic diagram of power supply for a data driver according to an embodiment of the present disclosure. A data driver provided in this embodiment is powered by a Timer Control (TCON). TCON is configured to provide various voltage signals supporting the operation of the data driver. Generally, TCON includes a power management integrated circuit (PMIC) which is configured to output digital power signals, analog power signals, semi-analog power signals, etc. according to input signals. For large-size and high-resolution liquid crystal display devices, because the required power for an analog power supply is too large for a single PMIC to bear. Therefore, in this exemplary embodiment, a voltage signal is supplied to the data driver through a Boost circuit. As shown in FIG. 4, TCON includes a PMIC configured to output analog power signal AVDD and semi-analog power signal HAVDD according to input signal Vin and a Boost circuit configured to output analog power signal AVDDS according to input signal Vin. The analog power signals AVDD and AVDDS are of the same voltage. TCON can be powered by the analog power signal AVDD generated by PMIC, and the data driver provided in this embodiment can be powered by the analog power signal AVDDS generated by the Boost circuit to provide driving capability.

In this embodiment, because the first data signal and the second data signal with different voltage polarities are controlled separately, the climbing speeds of the first data distribution signal and the second data distribution signal provided by the data distribution unit in the data driver will be inconsistent during power-on reset, resulting in inconsistency between the output voltage of the first driving unit and the output voltage of the second driving unit. Data drivers will have a Charge Sharing process before the power-on reset ends, that is, the output terminal of the first driving unit and the output terminal of the second driving unit will be in short circuit. Therefore, there will be a short and large Inrush current between the first driving unit and the second driving unit (as shown by the dashed box in FIG. 5, when a plurality of data drivers are used, the short-term inrush current I-AVDDS can reach 10 A), and the large inrush current will burn the Boost circuit of TCON.

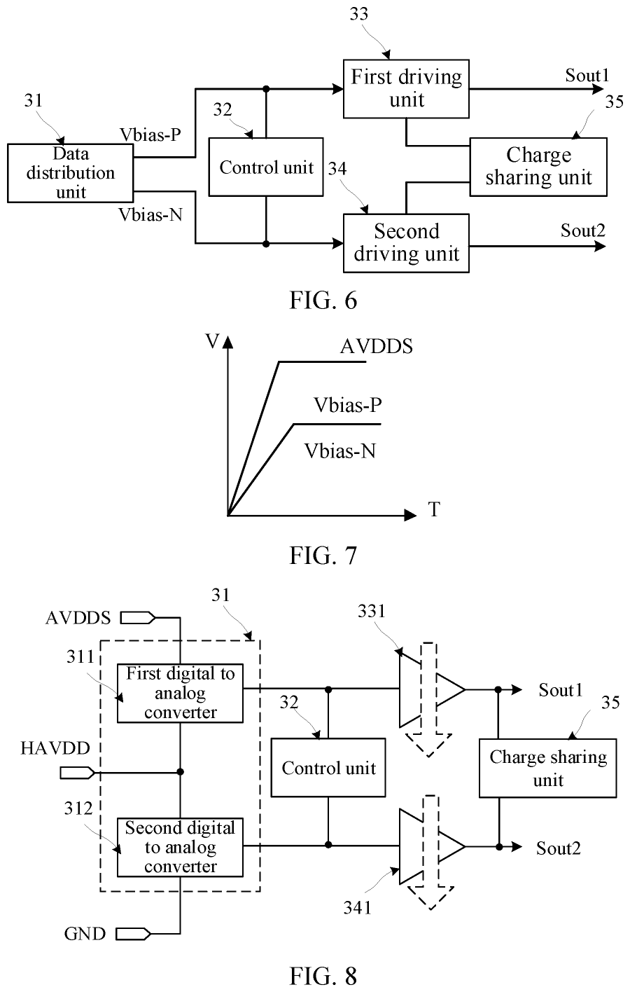

According to the data driver provided by the embodiment of the disclosure, a control unit is provided to solve the above-mentioned problem of large current inrush. FIG. 6 is a schematic diagram of the structure of a data driver according to an embodiment of the present disclosure. As shown in FIG. 6, the data driver provided by the embodiment of the present disclosure includes a data distribution unit 31, a control unit 32, a first driving unit 33, a second driving unit 34 and a charge sharing unit 35.

As shown in FIG. 6, the data distribution unit 31 provides a first data distribution signal Vbias-P to the input terminal of the first driving unit 33 and a second data distribution signal Vbias-N to the input terminal of the second driving unit 34. The first driving unit 33 is configured to generate a first data signal Sout1 according to the first data distribution signal Vbias-P. The second driving unit 34 is configured to generate a second data signal Sout2 according to the second data distribution signal Vbias-N. The voltage polarities of the first data signal and the second data signal are different. In this example, the voltage polarity of the first data signal is positive and the voltage polarity of the second data signal is negative.

In this embodiment, the control unit 32 is coupled to the input terminal of the first driving unit 33 and the input terminal of the second driving unit 34. When the power-on reset signal is not detected (i.e., before power-on reset), the control unit 32 controls the input terminals of the first driving unit 33 and the input terminal of the second driving unit 34 to be in short circuit, making the short circuit status maintained between the first driving unit 33 and the second driving unit 34, i.e. the first data distribution signal Vbis-P and the second data distribution signal Vbis-N maintain at the same potential, and thus, the heavy current inrush will be eliminated and the Boost circuit will be protected from being burned. When detecting the power-on reset signal, the control unit 32 controls the input terminal of the first driving unit 33 and the input terminal of the second driving unit 34 to be disconnected, making an open circuit state maintained between the first driving unit 33 and the second driving unit 34 to allow separate control for the first data distribution signal Vbis-P and the second data distribution signal Vbis-N and to thereby allow separate control of the first data signal Sout1 output by the first driving unit 33 and the second data signal Sout2 output by the second driving unit 34. For example, the short-term line afterimage will be alleviated by controlling the falling edge delay time of the second data signal to be longer than the rising edge delay time of the first data signal.

In this embodiment, the power-on reset signal may be generated when the data driver starts outputting after being powered on. The power-on reset signal may indicate a period during which the data driver starts to output the data signal. For example, the power-on reset signal may be generated by a power-on reset circuit, and the control unit 32 may be coupled to the power-on reset circuit to detect the power-on reset signal. The control unit 32 may control the input terminal of the first driving unit 33 to be disconnected from the input terminal of the second driving unit 34 when the power-on reset signal is detected, and may control the input terminal of the first driving unit 33 and the input terminal of the second driving unit 34 to be in short circuit at other times. For example, the control unit 32 may control the input terminal of the first driving unit 33 to be disconnected from the input terminal of the second driving unit 34 when detecting the power-on reset signal of the first potential, the first potential being either a high potential or a low potential. This disclosure does not limit the mode of generating the power-on reset signal or the form of the power-on reset signal generated.

In an exemplary embodiment, the control unit 32 may include one or more switching transistors. The implementations of the control unit 32 are not limited to the above as long as its functions can be achieved.

As shown in FIG. 6, the output terminal of the first driving unit 33 and the output terminal of the second driving unit 34 are coupled to the charge sharing unit 35. Under the control of the charge sharing control signal, the charge sharing unit 35 may make the output terminal of the first driving unit 33 and the output terminal of the second driving unit 34 share charges, which means the output terminal of the first driving unit 33 and the output terminal of the second driving unit 34 are in short circuit to reduce power consumption. The charge sharing unit 35 may include one or more switching transistors. However, the present disclosure does not limit the implementations of the charge sharing unit 35 as long as its functions may be realized.

FIG. 7 is a schematic diagram of a first data distribution signal and a second data distribution signal in an embodiment of the present disclosure. As shown in FIG. 7, under the control of the control unit 32, the first data distribution signal Vbias-P and the second data distribution signal Vbias-N are the same, and there is no voltage difference between them, which will prevent the burning of the Boost circuit because no heavy current inrush will occur during charge sharing.

FIG. 8 is a schematic diagram of the structure of a data driver in an embodiment of the present disclosure. As shown in FIG. 8, based on the data driver shown in FIG. 6, the data distribution unit 31 in this embodiment includes a first digital to analog converter (DAC) 311 and a second digital to analog converter 311 and the first driving unit includes a first operational amplifier 331, and the second driving unit includes a second operational amplifier 341. The output terminal of the first digital to analog converter 311 is coupled to the input terminal of the first operational amplifier 331, and the output terminal of the second digital-to-analog converter 312 is coupled to the input terminal of the second operational amplifier 341. The output terminal of the first operational amplifier 331 and the output terminal of the second operational amplifier 341 are coupled to the charge sharing unit 35 respectively. For example, the first operational amplifier 331 may be a positive signal amplifier, and the second operational amplifier 341 may be a negative signal amplifier.

As shown in FIG. 8, the first digital to analog converter 311 is configured to receive an analog power supply signal AVDDS and a semi-analog power supply signal HAVDD while the second digital to analog converter 312 is configured to receive semi-analog power supply signal HAVDD and ground signal GND. The first digital to analog converter 311 may generate a first data distribution signal Vbias-P and provide the signal to the input terminal of the first operational amplifier 331. The second digital to analog converter 312 may generate a second data distribution signal Vbias-N and provide the signal to the second operational amplifier 312 to support the first operational amplifier 331 and the second operational amplifier 341 to generate independent currents (as shown by the dashed line in FIG. 8).

In this embodiment, when the control unit 32 does not receive any power-on reset signal, the whole data driver may work in a charge sharing state, that is, the output terminals of all channels are in one short circuit together via the charge sharing unit 35 to neutralize positive and negative charges. Furthermore, the control unit 32 may control the output terminal of the first data converter 311 and the output terminal of the second data converter 312, making them in short circuit, i.e. control the first data distribution signal Vias-P and the second data distribution signal Vbias-N to maintain at the same potential. After detecting or receiving the power-on reset signal, the control unit 32 controls the output terminal of the first data converter 311 and the output terminal of the second data converter 312 to be disconnected, allowing the first operational amplifier 331 and the second operational amplifier 341 to work separately to generate negative frame data signals with longer falling edge delay time, so as to alleviate the short-term line afterimage.

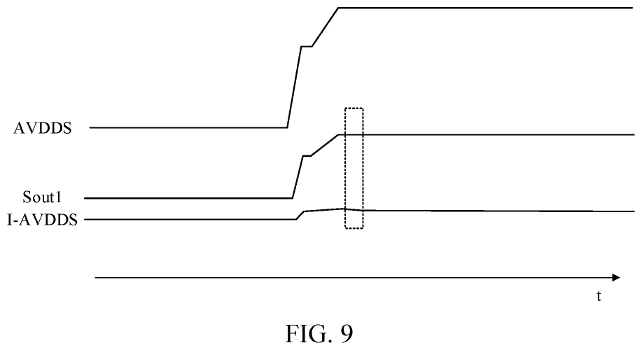

FIG. 9 is a schematic diagram of the effect of a data driver in an embodiment of the present disclosure. As shown in FIG. 9, compared with that shown in FIG. 5, under the same power-on condition, the current inrush I-AVDD of the data driver is not abnormally large, and the output terminal Sout1 is not abnormally lifted. It may be seen that the data driver provided in this embodiment may solve the problem of large current inrush as shown in FIG. 5 and may thereby improve the stability and safety of the circuit. The abscissa in FIGS. 5 and 9 represents time (t).

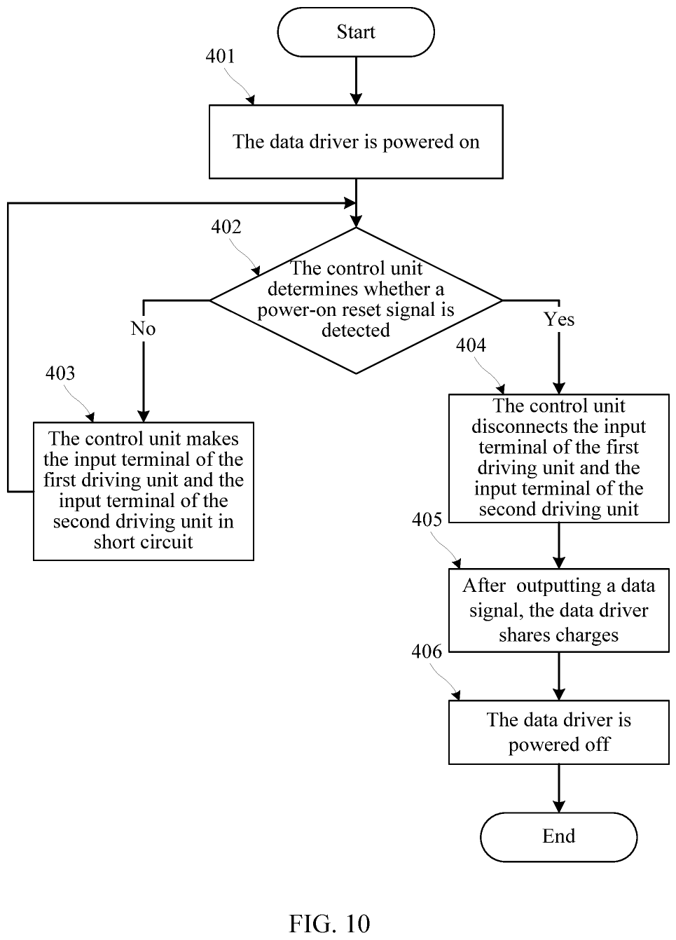

FIG. 10 is a flowchart of the operation of a data driver in an embodiment of the present disclosure. The data driver in the embodiment may be that shown in FIG. 6. As shown in FIG. 10, the operation of the data driver according to an embodiment of the present disclosure includes following steps:

Step 401: The data driver is powered on. For example, the data driver receives the voltage signal provided by TCON, including the analog power supply signal AVDDS and the semi-analog power supply signal HAVDD.

Step 402: The control unit of the data driver determines whether the power-on reset signal is detected. If the power-on reset signal is detected, step 404 is executed, and if the power-on reset signal is not detected, step 403 is executed. The power-on reset signal may be generated when the data driver starts outputting after being powered on. The power-on reset signal may indicate a period during which the data driver starts to output the data signal.

Step 403: In a case that the control unit does not detect a power-on reset signal, the control unit makes the input terminal of the first driving unit and the input terminal of the second driving unit in short circuit and then, returning to step 402, determine again whether the power-on reset signal is detected.

At step 404, In a case that the control unit detects the power-on reset signal, the control unit disconnects the input terminal of the first driving unit and the input terminal of the second driving unit, allowing the data distribution unit to provide the mutually independent first data distribution signal and second data distribution signal to the first driving unit and the second driving unit respectively. At this stage, the data driver may normally provide the first data signal and the second data signal to the data line via the first driving unit and the second driving unit.

Step 405: After normally providing data signals to the data lines, the data driver may share charges via the charge sharing unit.

Step 406: The data driver is powered off, i.e. TCON stops supplying power to the data driver.

The data driver provided by the embodiment of the present disclosure may alleviate the short-term line afterimage of the large-size and high-resolution liquid crystal display device in the starting process, and may solve the problem of large current inrush and may thereby improve the stability and safety of the circuit.

An embodiment of the present disclosure provides a control method to be applied to the data driver described above. The control method includes that the control unit controls the input terminal of the first driving unit and the input terminal of the second driving unit to be in short circuit or disconnected according to the power-on reset signal.

In an exemplary embodiment, the control unit controls the input terminal of the first driving unit and the input terminal of the second driving unit to be in short circuit or disconnected according to the power-on reset signal, which includes the following acts:

The control unit, when detecting no power-on reset signal, controls the input terminal of the first driving and the input terminal of the second driving unit to be in short circuit.

The control unit, when detecting the power-on reset signal, controls input terminal of the first driving and the input terminal of the second driving unit to be disconnected.

The descriptions of the above embodiments may be referred to for the structure and operation of the data driver according to this embodiment which will not be described here.

An embodiment of the present disclosure further provides a display device including the data driver circuit according to the previous embodiments. The display device may include a plurality of data drivers described in the previous embodiments. The display device may any product or component having a display function such as a liquid crystal display, a mobile phone, a tablet computer, a television, a display, a laptop, a digital photo frame, a navigator, etc. In the description of embodiments of the present disclosure, orientation or positional relationships indicated by terms “middle”, “upper”, “lower”, “front”, “back”, “vertical”, “horizontal”, “top”, “bottom”, “inside”, “outside” and the like are based on the orientation or positional relationships shown in the drawings, and are for the purpose of ease of description of the present disclosure and simplification of the description only, but are not intended to indicate or imply that the mentioned device or element must have a specific orientation, or be constructed and operated in a particular orientation, and therefore they should not be construed as limitation to the present disclosure.

Although the embodiments disclosed in the present disclosure are as described above, the described contents are only the embodiments for facilitating understanding of the present disclosure, which are not intended to limit the present disclosure. Any person skilled in the art to which the present disclosure pertains may make any modifications and variations in the form and details of implementation without departing from the spirit and scope of the present disclosure. Nevertheless, the scope of patent protection of the present disclosure shall still be determined by the scope defined by the appended claims.

What is claimed is:

1. A data driver, comprising:
a control unit, a data distribution unit, a first driving unit and a second driving unit, wherein
the data distribution unit is coupled with an input terminal of the first driving unit and an input terminal of the second driving unit respectively and is configured to provide a first data distribution signal to the input terminal of the first driving unit and a second data distribution signal to the input terminal of the second driving unit;
the first driving unit is configured to generate a first data signal according to the first data distribution signal, and the second driving unit is configured to generate a second data signal according to the second data distribution signal, the first data signal and the second data signal having different voltage polarities; and
the control unit is coupled with the input terminal of the first driving unit and the input terminal of the second driving unit respectively, and is configured to control the input terminal of the first driving unit and the input terminal of the second driving unit to be in short circuit or disconnected according to a power-on reset signal.

2. The data driver according to claim 1, wherein the control unit is configured to control the input terminal of the first driving unit and the input terminal of the second driving unit to be in short circuit when not detecting the power-on reset signal and to control the input terminal of the first driving unit and the input terminal of the second driving unit to be disconnected when detecting the power-on reset signal.

3. The data driver according to claim 1, wherein the data distribution unit comprises a first digital to analog converter and a second digital to analog converter, wherein the first driving unit comprises a first operational amplifier and the second driving unit comprises a second operational amplifier, wherein
an output terminal of the first digital to analog converter is coupled with an input terminal of the first operational amplifier, and an output terminal of the second digital to analog converter is coupled with an input terminal of the second operational amplifier.

4. The data driver according to claim 1, wherein a voltage polarity of the first data signal is positive, a voltage polarity of the second data signal is negative, and a falling edge delay time of the second data signal is longer than a rising edge delay time of the first data signal.

5. The data driver according to claim 1, wherein the data distribution unit is configured to receive an analog power supply signal generated by a boost circuit within a timing controller and a semi-analog power supply signal generated by an integrated power management circuit within the timing controller.

6. The data driver according to claim 1, further comprising: a charge sharing unit coupled to an output terminal of the first driving unit and an output terminal of the second driving unit respectively.

7. A display device, comprising the data driver according to claim 1.

8. A control method for a data driver, applied to the data driver according to claim 1, which comprises:
the control unit controls the input terminal of the first driving unit and the input terminal of the second driving unit to be in short circuit or disconnected according to the power-on reset signal

9. The control method according to claim 8, wherein the control unit controls the input terminal of the first driving unit and the input terminal of the second driving unit to be in short circuit or disconnected according to the power-on reset signal, which comprises:
the control unit, when not detecting power-on reset signal, controlling the input terminal of the first driving and the input terminal of the second driving unit to be in short circuit; and
the control unit, when detecting the power-on reset signal, controlling the input terminal of the first driving and the input terminal of the second driving unit to be disconnected.
